(19) United States
(12) Patent Application Publication
(10) Pub. No.: US 2025/0242443 A1
(43) Pub. Date: Jul. 31, 2025

(54) ULTRAFAST-LASER-BASED FIGURING AND MID-SPATIAL FREQUENCY ERROR CORRECTION

(71) Applicants: Jie Qiao, Brighton, NY (US); Gong Chen, Rochester, NY (US)

(72) Inventors: Jie Qiao, Brighton, NY (US); Gong Chen, Rochester, NY (US)

(73) Assignee: Rochester Institute of Technology, Rochester, NY (US)

(21) Appl. No.: 19/038,024

(22) Filed: Jan. 27, 2025

Related U.S. Application Data
(60) Provisional application No. 63/625,521, filed on Jan. 26, 2024.

(51) Int. Cl. B23K 26/352

(52) U.S. Cl. CPC B23K 26/355

(57) ABSTRACT

Methods and systems for optical figuring to create a periodic pattern using an ultrafast laser and for removing material from peaks down to the valleys of mid-spatial-frequency (MSF) errors with an ultrafast laser resulting in the surface smoothness to single-digit-nanometer surface roughness are disclosed.

### CROSS REFERENCE

This application claims the benefit of the filing date of U.S. Provisional Patent Application No. 63/625,521, filed Jan. 26, 2024, which is hereby incorporated by reference in its entirety.

### FIELD

The present disclosure relates to a method and system for optical figuring to create a periodic pattern using an ultrafast laser and for removing peaks down to the valleys of mid-spatial-frequency (MSF) errors with an ultrafast laser resulting in a surface smoothness to single-digit-nanometer surface roughness.

### BACKGROUND

Sub-aperture manufacturing techniques have been widely used for fabricating high-precision optical components, such as freeform and aspherical surfaces, for compact and high-performance imaging systems. Deterministic sub-aperture polishing locally removes material using a small tool. The material is removed using dwell-based algorithms based on the initial surface figure and tool influence function. However, surfaces manufactured with these sub-aperture techniques, such as diamond turning, grinding, and magnetorheological finishing, can leave residual periodic ripples, or mid-spatial-frequency (MSF) surface errors, which can be a spiral, a spoke, or a raster pattern, depending on the sub-aperture tool path. The periodicity of MSF errors is in the sub-millimeter to millimeter range. Small-angle scatter from the MSF errors degrades the achievable resolution of imaging systems. For laser applications, the MSF-error-induced diffraction patterns can turn into intensity modulation, causing downstream optics damage. Thus, it is desirable to mitigate or remove MSF errors in manufacturing precision optics.

Mid-spatial-frequency (MSF) errors on optical surfaces can exhibit various patterns, such as spirals, spokes, or raster patterns, depending on the sub-aperture tool path employed during fabrication. The MSF pattern is characterized by the peak to valley height variation and spatial frequency. The periodicity of MSF errors is in the sub-millimeter to millimeter range. To effectively mitigate the magnitude of MSF errors, it is important to optimize processing algorithms during fabrication or employ post-processing methods. Although the magnitude of MSF errors can be reduced by such methods, most strategies are limited because of the slope variations on freeform or aspheric surfaces. Various approaches have been explored to overcome this limitation, such as the implementation of conformal polishing laps and the development of custom fiber-based finishing tools, both of which have demonstrated promising results in mitigating MSF errors. Additionally, pseudo-random post-polishing techniques have been investigated to effectively reduce MSF errors while preserving the overall surface form. However, all these methods are based on mechanical and/or chemical polishing tools.

Most prior strategies are limited because the slope variations on freeform or aspheric surfaces can be steep and drastic. Therefore, the contact-based polishing tools become insufficient for significant slope variations. Compared to the prior technology, ultrafast-laser-based optical figuring and MSF reduction are non-contact and flexible. Therefore, it is not limited by the slope variations. Furthermore, it is environmentally friendly because there is no chemical waste involved. Lasers are an attractive alternative to correct MSF errors. Previous works, such as surface micro structuring by remelting, laser-induced plasma micro-machining, and pulsed laser ablation, have been used for creating and controlling surface structures. However, these methods are typically used for micrometer-level structuring and, therefore, cannot precisely correct MSF errors that are often less than one micrometer. Moreover, some methods require complex physical modeling of laser ablation or material ejection to predict the resulting surface structures. Continuous-wave and longer pulse laser processing have been used for polishing and form correction, but the resulting surfaces come with subsurface damage and heat-affected zone.

### SUMMARY

In accordance with one aspect of the present disclosure, there is provided a method for non-contact ultrafast-laser-based mid-spatial frequency (MSF) error reduction, including:
measuring a surface profile of a pattern of mid-spatial-frequency (MSF) errors on an optical surface;
quantifying height magnitude, location, and peak-to-valley (PV) of the height variation of three-dimensional (3D) features of the surface profile characterizing the height and spatial position of all the 3D features in the MSF pattern; and
removing material from the 3D features to reduce the height down to the valley of the mid-spatial-frequency (MSF) errors with an ultrafast laser using an inverse value of the measured surface profile to smoothness of the optical surface to single-digit-nanometer surface roughness.

In accordance with another aspect of the present disclosure, there is provided a method for optical figuring to create a periodic pattern on an optical surface using an ultrafast laser, including:
generating a groove by removing material from an optical surface using raster line scans;
measuring a surface profile of the generated groove;
predicting a periodic pattern using the surface profile of the generated groove and Equation (1); and
creating the predicted periodic pattern in the optical surface by overlapping the generated groove according to Equation (1), using an ultrafast laser.

In accordance with another aspect of the present disclosure, there is provided a method for optical figuring to create a periodic pattern on an optical surface using an ultrafast laser and for non-contact ultrafast-laser-based reduction of material from the periodic pattern, comprising:
generating a groove by removing material from an optical surface using raster line scans using the ultrafast laser;
measuring a surface profile of the generated groove;
predicting a periodic pattern using the surface profile of the generated groove and Equation (1);
creating the predicted periodic pattern in the optical surface by overlapping the generated groove according to Equation (1), using the ultrafast laser;
measuring a surface profile of mid-spatial-frequency (MSF) errors in the created periodic pattern in the optical surface;
quantifying height magnitude, location, and peak-to-valley (PV) of the height variation of three-dimensional (3D) features of the surface profile characterizing the height and spatial position of all the 3D features in the MSF pattern; and
removing material from the 3D features to reduce the height down to the valley of the mid-spatial-frequency (MSF) errors with the ultrafast laser using an inverse value of the measured surface profile to smoothness of the optical surface to single-digit-nanometer surface roughness.

These and other aspects of the present disclosure will become apparent upon a review of the following detailed description and the claims appended thereto.

### BRIEF DESCRIPTION OF THE DRAWINGS

FIG. 1A is a surface profile of the laser-ablated groove and FIG. 1B is a graph of a horizontally integrated line profile;

FIG. 2A and FIG. 2C show a surface map of two periodic grooves having a spacing of 160 μm and 120 μm, respectively and FIG. 2B and FIG. 2D show overlays of experimentally achieved and theoretically predicted surface profiles for spacing of 160 μm and 120 m, respectively;

FIG. 3A is a surface profile of the generated sinusoidal pattern and FIG. 3B is a horizontally integrated line profile;

FIG. 4 is a graph showing removal depth linearly increases with the number of area passes (dots), and the diamond represents the number of passes required to remove the peaks of the sinusoidal pattern; and

FIG. 5A is a surface profile after fs-laser correction and FIG. 5B is a horizontally integrated line profile.

### DETAILED DESCRIPTION

This disclosure includes the systems, methods, and processes for optical figuring and mid-spatial frequency (MSF) error reduction using ultrafast laser systems. Femtosecond (fs)-laser processing is a promising technique for MSF error mitigation. Fs-laser processing enables nanometer-precision material removal without inducing thermal melting and sub-surface damage. Deterministic material removal guided by total deposited energy density can be tailored to correct different surface form errors. High processing quality with a sub-nanometer optical surface can be achieved by simultaneous surface figuring and finishing using a femtosecond laser.

Disclosed is a system, methodology, modeling, and process for high-precision optical figuring to create a desired spatial pattern and for mid-spatial frequency (MSF) error reduction of optical material using femtosecond lasers, i.e., selectively removing material to create surface structure and to remove MSF errors, independently or in combination.

A periodical pattern can be specified to mimic a mid-spatial frequency error to demonstrate that laser figuring can be used to create periodical patterns with different peak-to-valley amplitudes and periodicities.

In an embodiment, a method for optical figuring to create a periodic pattern using an ultrafast laser includes the following steps:
1) Generate a groove in an optical surface using raster line scans. For example, a groove whose width is half of the periodicity, wherein the depth of the groove can be controlled by a combination of laser parameters including fluence, repetition rate, speed, number of scans, and the like.
2) Measure the surface profile of the groove.
3) Predict a periodic pattern using the surface profile of the created groove and Equation (1).
4) Create the predicted periodic pattern by overlapping the groove according to Equation (1), using an ultrafast laser system.

In an embodiment, a method for mid-spatial frequency (MSF) error reduction using an ultrafast laser includes the following steps:
1) measuring the surface profile of the MSF pattern on an optical surface;
2) quantifying the height magnitude, location, and peak-to-valley (PV) of the height variation of three-dimensional (3D) features of the surface profile characterizing the height and spatial position of all the 3D features in the MSF pattern;
3) removing material from the 3D features to reduce the height down to the valley of the mid-spatial-frequency (MSF) errors with an ultrafast laser using an inverse value of the measured surface profile; and
4) achieving a resulting smoothness of the optical surface to within a single-digit-nanometer surface roughness.

Periodic patterns are generated on the surface using a femtosecond laser. A periodic pattern is formed by producing overlapping grooves. Such grooves can be produced through raster scanning a laser beam on a surface, i.e., each groove is formed by overlapping a number of line scans of the laser beam. The designed groove width is half of the periodicity of the pattern to be generated. The actual groove width is determined by the width of each scan line, the number and separation of the scan lines.

This groove is equivalent to a tool pattern. The theoretical groove depth is determined by the removal depth per scan and the number of scans. The actual groove profile is measured using a white-light interferometer and extracted from the profile measurements. The associated peak and valley data are extracted from the profile measurements.

The configuration of the pattern to be figured can be represented by profile of the periodic pattern, predicted using Equation 1 shown below:

$${h}_{2 n + 1} ( x ) = {h}_{s} ( x ) + {h}_{s} ( x + d ) + {h}_{s} ( x - d ) + … + {h}_{s} ( x + n \times d ) + {h}_{s} ( x - n \times d ) \qquad Equation 1$$

Here hₛ(x) represents the single groove profile, d is the groove separation, and 2n+1 is the number of grooves. In a general case, the spatial pattern of a nano-micro structure can be predicted by convoluting a tool pattern (such as a groove) with a predefined tool path (such as a periodical pattern). The nano-micro structure can be subsequently created by scanning the tool pattern using the predefined tool path.

For example, we demonstrated the figuring of a sinusoidal-like pattern, measuring 5-cycles/mm periodicity and 17-nm peak-to-valley height. This was achieved using overlapping grooves having a width of 100 μm, a separation of 200 μm, and a depth of 21.6 nm. This pattern was also predicted by Eq. 1.

We measure and extract the ablated groove profile using a white-light interferometer. (Zygo NewView 600). The lateral spatial resolution of the interferometer is 2.2 μm. The longitudinal resolution of the interferometer is 0.1 nm, and the root mean squared (rms) repeatability is 0.01 nm.

Eq. 1 is used to predict and generate a periodical pattern that can be subsequently removed by a laser beam. To remove such periodical patterns either generated by a laser beam or from the conventional optical manufacturing methods, we measure the surface profile of the patterns first, quantifying the height magnitude and location of the peak and valley of each pillar on the surface, and characterizing the spatial dimension of each pillar in the pattern. We therefore remove the pillars by creating a laser-generated surface profile, using the inverse value of the measured surface profile, in combination with the previously characterized material-removal depth in relation to the number of area passes.

After shape correction, in an embodiment, the peak-to-valley height is reduced from 17 nm to 1.4 nm. This selective and deterministic material removal reduces MSF errors to the single-digit nanometer level in magnitude, resulting in an optical-quality surface.

The disclosure includes the following: Femtosecond laser figuring system and scanning strategy to achieve material removal with nanometer precision while maintaining optical surface quality. Method and process to create nano-to-microstructures having periodic, cyclical, or random spatial frequency. Method and process to eliminate or remove nano-to-microstructures, mid-spatial frequency or even large spatial surface error induced by the conventional optics fabrication methods. The selective material removal can be used to reduce MSF errors on optical materials including glass, crystal, polymer, semiconductors and metal materials.

The present techniques can be used to create nano-to-microstructures, to remove materials at the desired spatial location to eliminate or reduce mid-spatial frequency errors originated from the traditional polishing methods based on mechanical tools and chemical particles.

The ability to correct MSF errors in optical components can significantly improve their performance in imaging systems, telescopes, microscopes, lasers, and other optical instruments by reducing scattering, enhancing resolution, and minimizing aberrations. Moreover, MSF error correction can prevent optical damage caused by scattered energy in high-power laser systems, ensuring the integrity and performance of the laser beam.

Material description: Suitable substrate materials include for example germanium, silicon, glass, crystal, metal, diamond, sapphire, silicon carbide ceramics and polymer. Suitable materials also include optical and additively manufactured materials.

Laser description: Suitable ultrafast lasers include ultrafast lasers having a pulse duration of less than 50 picoseconds. These include femtosecond and picosecond lasers. Suitable wavelengths of the laser include but are not limited to 248 nm, 355 nm, 385 nm, 515 nm, 527 nm, 532 nm, 615 nm, 620 nm, 775 nm-800 nm, 825 nm, 1030±2 nm, 1045 nm, 1047 nm, 1053 nm, 1060 nm, 1064 nm, 1300 nm, 1550 nm, 1558 nm, and 2400 nm. Suitable repetition rates range from 1 kilohertz to several gigahertz in burst mode, with typical values including 1 kHz, 10 kHz, 100 kHz, and 250 kHz. The laser can be externally triggered and synchronized with a scanner that scans the laser beam to ensure the appropriate laser emission response for a given processing process.

Laser-based figuring can be used to create nano-to-microscale structures on flat, curved, and freeform surface; or to create nano-to-microstructures having periodic, cyclical, or random spatial frequency.

The nano structuring can be used to create antireflection surface structure.

Integration of the ultrafast-laser-based selective material removal can be applied to the optics fabrication process chain to realize advanced freeform optic forming, surface patterning, finishing, and reduction of detrimental mid-spatial-frequency errors.

Laser-ablation-based nano-or-micro-structuring can be used for the fabrication of anti-reflection coatings on flat, curved and/or freeform surfaces for both transmissive and reflective applications.

Selective material removal can be used for the fabrication of integrated photonics, such as creating optical waveguides with air cladding, generating electrode patterns, generating surface gratings, and others.

Selective nano-to-micro structuring has the potential to be used to create meta surfaces.

Compared to the state-of-the-art laser surface processing, this invention differs with respect to all the previous demonstrations of ultrafast laser ablation of transparent materials that have generated surfaces with micro rather than nanoscale surface roughness. This disclosure for the first time achieved material removal with nanometer precision and reduction of magnitude of periodic structure errors from, for example, 17 nm to 1.4 nm.

Many other researchers in the field often rely on continuous wave or nanosecond lasers for figuring and finishing processes that primarily rely on material melting. However, these approaches result in processed surfaces with subsurface damage and heat-affected zones. Some have attempted to use ultrafast laser-based ablation to polish glass with trial-and-error experimental approaches but have only been able to achieve micrometer level surface roughness.

By precisely controlling the spatial and temporal energy deposition through integrated physical modeling and experiments, the present disclosure has established effective figuring and finishing processes to remove materials with nanometer precision. This process balances non-thermal-based material breakdown and material-phase-change-induced removal through high-precision thermal control.

The present disclosure demonstrates nano-structuring and the reduction of mid-spatial-frequency errors using femtosecond laser figuring and finishing. Mid-spatial-frequency errors have been corrected from 17 nm to one nanometer in magnitude, resulting in sub-nanometer surface roughness. We established a method to create and predict periodic nanostructures. This demonstration opens the path of using femtosecond lasers for correcting surface errors that inherently result from sub-aperture manufacturing techniques.

Uses include the following:

Optics manufacturing: The ability to correct mid-spatial frequency errors in optical components can significantly improve their performance in imaging systems, telescopes, microscopes, and other optical instruments by reducing scattering, enhancing resolution, and minimizing aberrations.

Laser systems: the correction of mid-spatial frequency error on laser components can prevent optical damage caused by the MSF-pattern-induced diffraction and the subsequent intensity modulation in high-power laser systems, ensuring the integrity and performance of the laser beam.

Semiconductor industry: The method can be utilized in the fabrication of semiconductor devices, such as photomasks or lithographic masks, to correct surface errors and improve pattern fidelity during the manufacturing process.

Precision engineering: The method can be employed in the production of precision components and surfaces in industries such as aerospace, automotive, and medical devices, where high-accuracy and smooth surfaces are crucial for functionality and performance.

Apparatus, systems, methods, techniques, materials and processes included in the present disclosure include those disclosed in U.S. Pat. No. 11,471,980 entitled “Method and System for Ultrafast Laser-Based Material Removal, Figuring and Polishing”, which is hereby incorporated by reference in its entirety.

The disclosure will be further illustrated with reference to the following specific examples. It is understood that these examples are given by way of illustration and are not meant to limit the disclosure or the claims to follow.

Example 1—Optical structuring and mid-spatial frequency error reduction using femtosecond lasers. This experiment can be found in Chen G, Qiao J. Optical structuring and finishing toward mid-spatial-frequency error reduction using femtosecond lasers. Opt Lett. 2024 Mar. 15; 49(6):1560-1563. doi: 10.1364/OL.520008. PMID: 38489450, which is hereby incorporated by reference in its entirety.

We demonstrate nano-structuring and the reduction of mid-spatial-frequency errors using femtosecond laser figuring and finishing. We have corrected mid-spatial-frequency errors from 17 nm to one nanometer in magnitude. We established a method for creating and predicting periodic nanostructures. This demonstration opens the path of using femtosecond lasers to correct surface errors that inherently result from sub-aperture manufacturing techniques.

In this example, we demonstrate controllable surface topography creation and MSF error correction through simultaneous surface figuring and finishing of Borofloat 33 (BF33) glass using a femtosecond laser. We have achieved controllable shape correction with nanometer precision single-digit-nanometer surface roughness after the MSF error correction.

Experimental setup—An ytterbium fiber laser (Satsuma HP3, Amplitude Laser) with a central wavelength of 1030 nm and a pulse duration of 300 fs is used to process a BF33 substrate. The laser beam is focused onto the top surface of a substrate using a confocal imaging setup. The focused laser beam raster scans the substrate moved by high-precision translation stages (Jenny Science, Lxc 80F40) with a resolution of 100 nm. Pulse energies are precisely controlled by a Beam Shaper (LASEA, LS-Shape). To ensure a constant pulse energy deposition during laser processing, a control program in LabVIEW was developed to integrate the motion of the stages and the laser on/off signals.

### Experimental Results

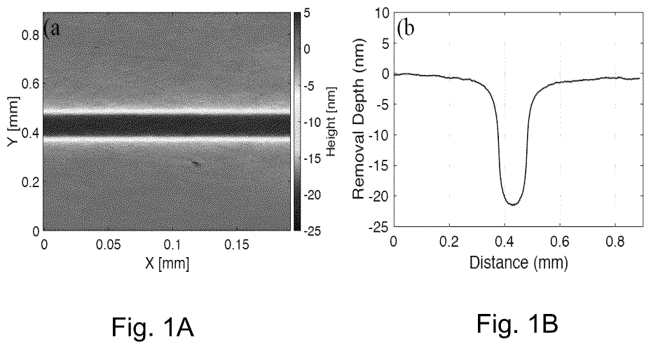

Surface nano-structuring—We investigate the nano-structuring of BF33 using a femtosecond laser. FIG. 1A displays the surface map of a laser-ablated groove, measured by a white light interferometer (Zygo NewView 600). The groove was generated by raster scanning an area measuring 0.2×0.1 mm². The scan-line overlap is 70%. The surface roughness in both the processed region after material removal and unprocessed region prior to material removal is approximately 0.5 nm in root mean squared (RMS). FIG. 1B shows the corresponding horizontally integrated vertical line profile. The removal depth is 21.6 nm, and the width defined as the full width at half maximum valley is 103 μm. The ratio of the ablated-groove width to the specified width is 1.03, which was used as a correction factor.

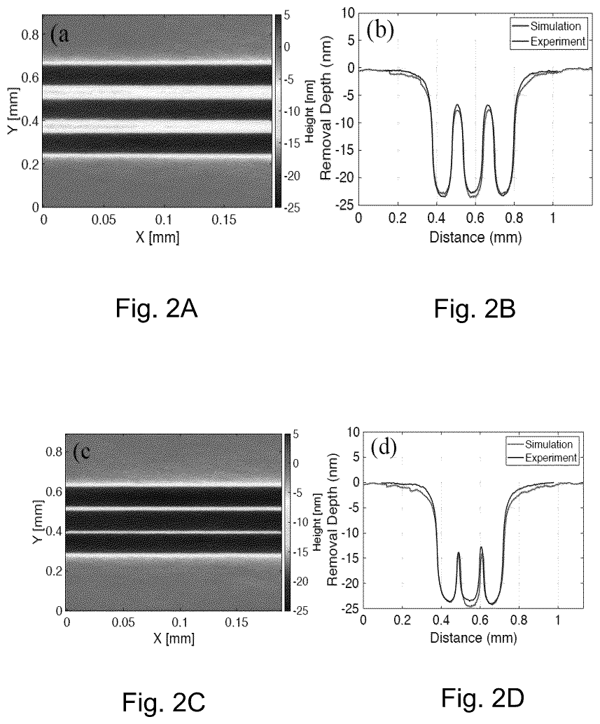

The influence of the groove separation on the periodic structure was experimentally investigated using a periodic structure consisting of 2n+1 single grooves, as expressed by Eq. (1). FIGS. 2A and 2C show the surface maps of two laser-created periodic structures with a 160 μm and 120 μm spacing, respectively. FIGS. 2B and 2D show the corresponding horizontally integrated line profiles. The geometry and morphology of the resulting periodic structures depend on the single-groove shape and the spacing between adjacent grooves. The pillar height decreases from 16.5 nm to 10.5 nm (peak-to-valley), and the width decreases from 58 μm to 20 μm (FWHM) when the groove spacing reduces from 160 μm to 120 μm. The laser-ablated grooves also agree with the simulated periodic features for these two groove spacings [FIGS. 2B and 2D], demonstrating the controllability of creating predictable periodic nanostructures using a femtosecond laser.

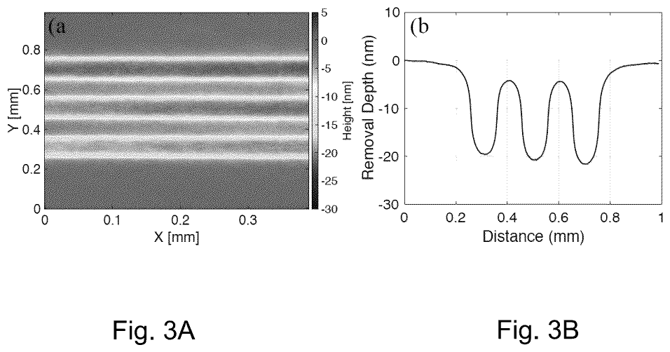

Mid-spatial frequency error correction—to demonstrate the fs-laser-based MSF error correction, we first use a femtosecond laser to generate periodic grooves having sub-millimeter periodicity using Eq. (1). The groove width and center-to center spacing between two adjacent grooves were set as 100 μm and 200 μm. FIG. 3A and FIG. 3B show the laser-created sinusoidal pattern having 5 cycles/mm, and the corresponding line profile (horizontally integrated), respectively. The surface measures a peak-to-valley (PV) height of 17 nm and a pillar width of 97 μm (FWHM).

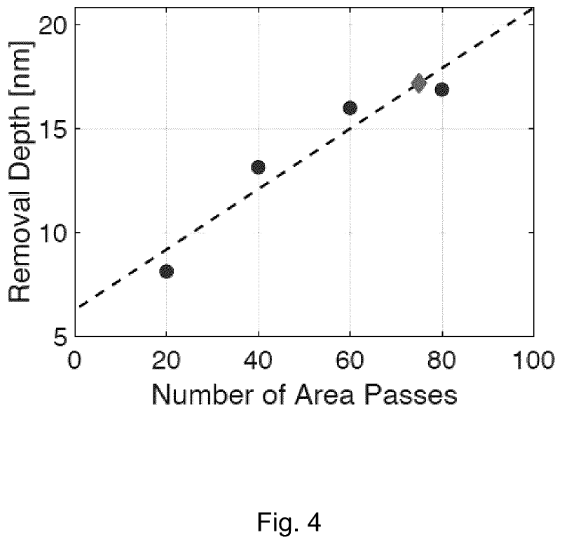

To remove each individual pillar, we constructed a laser-ablated groove by matching the pillar's size and location. The groove generated by area scan has the same width and location as the pillars in the periodical pattern. The required groove depth was further determined by performing a set of area scans (0.8 mm×0.1 mm) with an increasing number of passes. The material-removal depth in relation to the number of area passes was characterized and a linear relationship was derived and shown in FIG. 4. The deterministic material removal having nanometer-scale precision was then performed to remove the sinusoidal pattern. Seventy-five passes of area scans were performed to remove a peak value of 17 nm.

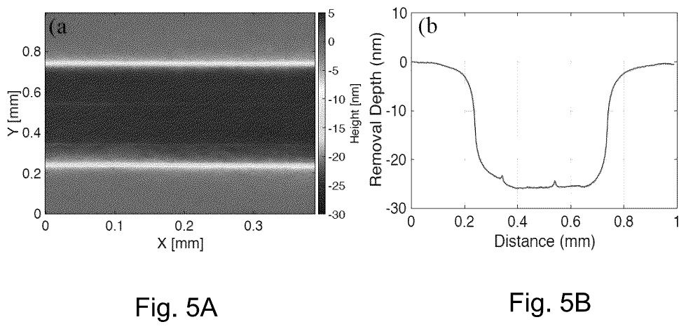

FIGS. 5A and 5B, respectively, show the surface profile and the corresponding line profile after fs-laser shape correction. The MSF pattern having a peak-to-valley of 17 nm is reduced to 1.4 nm. A complete PV reduction is achievable with parameter optimization.

Conclusion—We have demonstrated controllable nanostructure creation and MSF error correction on glass material, BF33, using fs-laser processing. This selective and deterministic material removal reduces mid-spatial-frequency errors to the single-digit nanometer level in magnitude, resulting in an optical-quality surface. This demonstration opens the path of optical nano-structuring and MSF correction using fs laser processing. Additionally, the ability to create desirable surface topographies makes the method promising for fabricating integrated photonic and laser devices.

Although various embodiments have been depicted and described in detail herein, it will be apparent to those skilled in the relevant art that various modifications, additions, substitutions, and the like can be made without departing from the spirit of the disclosure and these are therefore considered to be within the scope of the disclosure as defined in the claims which follow.

What is claimed:

1. A method for non-contact ultrafast-laser-based mid-spatial frequency (MSF) error reduction, comprising:
measuring a surface profile of a pattern of mid-spatial-frequency (MSF) errors on an optical surface;
quantifying height magnitude, location, and peak-to-valley (PV) of height variation of three-dimensional (3D) features of the surface profile characterizing the height and spatial position of all the 3D features in the pattern of the mid-spatial-frequency (MSF) errors; and
removing material from the 3D features to reduce the height down to the valley of the mid-spatial-frequency (MSF) errors with an ultrafast laser using an inverse value of the measured surface profile to a smoothness of the optical surface to single-digit-nanometer surface roughness.

2. The method of claim 1, wherein the ultrafast laser comprises a femtosecond or picosecond laser, having a pulse duration of less than 50 picoseconds, having a repetition rate from 1 kilohertz to several gigahertz (in burst mode).

3. The method of claim 1, wherein the optical surface is flat, curved, or freeform.

4. The method of claim 1, wherein the material comprises germanium, silicon, metal, glass, crystal, ceramic, polymer, optical or additively manufactured material.

5. A method for optical figuring to create a periodic pattern on an optical surface using an ultrafast laser, comprising:
generating a groove by removing material from an optical surface using raster line scans;
measuring a surface profile of the generated groove;
predicting a periodic pattern using the surface profile of the generated groove and Equation (1); and
creating the predicted periodic pattern in the optical surface by overlapping the generated groove according to Equation (1), using an ultrafast laser.

6. The method of claim 5, wherein the ultrafast laser comprises a femtosecond or picosecond laser, having a pulse duration of less than 50 picoseconds, having a repetition rate from 1 kilohertz to several gigahertz (in burst mode).

7. The method of claim 5, wherein the optical surface is flat, curved, or freeform.

8. The method of claim 5, wherein the material comprises germanium, silicon, metal, glass, crystal, ceramic, polymer, optical or additively manufactured material.

9. A method for optical figuring to create a periodic pattern on an optical surface using an ultrafast laser and for non-contact ultrafast-laser-based reduction of material from the periodic pattern, comprising:
generating a groove by removing material from an optical surface using raster line scans using the ultrafast laser;
measuring a surface profile of the generated groove;
predicting a periodic pattern using the surface profile of the generated groove and Equation (1);
creating the predicted periodic pattern in the optical surface by overlapping the generated groove according to Equation (1), using the ultrafast laser;
measuring a surface profile of mid-spatial-frequency (MSF) errors in the created periodic pattern in the optical surface;
quantifying height magnitude, location, and peak-to-valley (PV) of height variation of three-dimensional (3D) features of the surface profile characterizing the height and spatial position of all the 3D features in the pattern of the mid-spatial-frequency (MSF) errors; and
removing material from the 3D features to reduce the height down to the valley of the mid-spatial-frequency (MSF) errors with the ultrafast laser using an inverse value of the measured surface profile to a smoothness of the optical surface to single-digit-nanometer surface roughness.
